(19) United States
(12) Patent Application Publication
(10) Pub. No.: US 2011/0107652 A1
(43) Pub. Date: May 12, 2011

(54) Ice Fishing Apparatus

(76) Inventor: Kenneth Lee Getzinger, Lashburn (CA)

(21) Appl. No.: 12/945,088

(22) Filed: Nov. 12, 2010

(30) Foreign Application Priority Data
Nov. 12, 2009 (CA) 2686005

(51) Int. Cl. A01K 97/10; A01K 87/00

(52) U.S. Cl. 43/19.2; 43/21.2; 43/17

(57) ABSTRACT

An ice fishing apparatus features a support stand engaging and projecting upward from a frozen surface of a body of water and projecting laterally outward at a distance above the frozen surface. A flexible strip has a fixed end coupled to the stand and extends past a distal end laterally outward from the upright portion of the stand engaged in the ice. A wind flap is coupled to the flexible strip at a position therealong between the distal end of the stand and a free end of the flexible strip. A reel support is provided on the support stand and a clip near the free end of the strip is used for gripping fishing line from the reel to move the hook end of the line with the strip under action of moving air on the wind flap.

This application claims benefit under 35 U.S.C. 119(a) of Canadian Patent Application Serial No. 2,686,005, filed Nov. 12, 2009, the entirety of which is incorporated herein by reference.

### FIELD OF THE INVENTION

The present invention relates generally to ice fishing apparatus, and more particularly to a apparatus with an L-shaped stand presenting a laterally projecting arm on which a reel is supported and from which a flexible strip extends to carry a wind flap and line guide so that the lure on the fishing line passing through the guide experiences automatic wind-driven up and down jigging action in the water.

### BACKGROUND OF THE INVENTION

It is known in the art of fishing to employ an apparatus for ice fishing known as a tip-up. Such an apparatus is placed over or beside the hole bored in the covering layer of ice on a frozen over body of water and supports a reel of fishing line. The hook and bait equipped end of the fishing line is lowered into the water through the hole in the ice. A fisherman can thus attempt to catch fish at this particular opening in the ice without having to remain right next to that specific holes, for example leaving him free to instead simultaneously fish at another such hole in close proximity will often employ a mechanism that is actuated by pulling of the fishing line when struck by a bite and erects a normally biased-down flag, actuates another type of visual signal or audible alarm or in some way provides the fisherman with an indication of the strike, so that the fisherman can return to the opening in the ice to retrieve his catch. Some of the prior art tip ups employ a vane or wind catching device to oscillate a member from which the fishing line depends into the hole in the ice to effect an automatic wind-driven jigging action repeatedly and alternately lifting and lowering the baited hook in the water.

However, there remains room for further development in this field, and the present invention is accordingly presented herein with a number of unique features not previously proposed.

### SUMMARY OF THE INVENTION

According to a first aspect of the invention there is provided an ice fishing apparatus comprising:

a support stand comprising:
a first stand element having a first end thereof arranged to engage a frozen surface of a body of water with the first stand element projecting upward therefrom; and
a second first stand element coupled to the first stand element at a connection point spaced from the first end thereof in a position projecting laterally therefrom at a distance above the frozen surface;

a flexible strip having a fixed end coupled to the second stand element and extending past a distal end of the second stand element opposite the first stand element;

a wind flap coupled to the flexible strip at a position therealong between the distal end of the second stand element and a free end of the flexible strip opposite the fixed end thereof;

a reel support arrangement coupled to the support stand to support a reel of fishing line thereon; and

a line guide coupled to the flexible strip proximate the free end thereof for passage of the fishing line therethrough.

Preferably the second stand element is releasable from the position projecting laterally from the first stand element.

Preferably the second stand element is selectively detachable from the first stand element at the connection point;

Preferably a flexible link connects the first and second stand elements to prevent complete separation thereof when the second stand elements are detached at the connection point.

Preferably the second stand element is movable into a position extending along the first stand element for storage.

Preferably the connection point is defined by a branched connector receiving ends of the first and second stand elements in hollow branches of the connector disposed at rights angles to one another.

Preferably at least one of the stand elements comprises a respective length of tubing.

Preferably each length of tubing comprises metal tubing. Alternatively, wood or plastic members may be used.

Preferably each length of tubing is rectangular in cross-section, for example square. Alternatively round tubing may be used.

The reel support arrangement may comprise a rod holder coupled to the stand proximate the second stand element and arranged to receive a handle end of a fishing rod in order to support the fishing rod and a fishing line reel installed thereon on the stand element so that the fishing rod extends from the rod holder along an axis thereof toward the distal end of the second stand element.

Preferably a pivotal connection supports the rod holder on the stand to pivot about a horizontal axis transverse to the second stand element between a lowered rod position and a raised rod position in which the axis of the rod holder angles upwardly moving along the axis toward the distal end of the second stand element more than in the lowered rod position, and the ice fishing apparatus further comprises a biasing device on the stand arranged to bias the rod holder into the raised rod position relative to the stand and a catch device movable between an engaged position retaining the rod holder in the lowered rod position against the bias of the biasing device and a disengaged position releasing the rod holder to trigger movement thereof the rod holder into the raised rod position under the bias of the biasing device.

Preferably the biasing device comprises an elastic member to connect to the stand at a position on one side of the pivotal connection opposite the distal end of the second stand element and connect to the rod holder on an opposite side of the pivotal connection to pull a rod-receiving end of the rod holder upwardly about the horizontal axis.

Preferably the elastic member comprises a bungee cord.

When in combination with the fishing rod, the elastic member may extend about a feature of the fishing rod at a portion thereof projecting from the rod receiving end of the rod holder to pull the rod receiving end of the rod holder upwardly about the horizontal axis toward where the two ends of the elastic member connect to the second stand element. In this instance, preferably the elastic member extends about a finger grip of the fishing rod.

The first and second stand elements may be connected by a T-junction with the elastic member having two ends secured to the stand on the one side of the pivotal connection by hooking into an open end of a branch of the T-junction opposite another branch thereof supporting the second stand element.

Preferably the catch device is movably supported on one of the support stand and the rod holder and movable relative thereto, the catch device engaging a catch element on an opposite one of the support stand and the rod holder in the engaged position to retain the rod holder in the lowered rod position.

Preferably the catch element comprises a lateral projection on the opposite one of the stand and the rod holder and the catch device on the one of the stand and the rod holder bends over or under the lateral projection respectively in the engaged position.

When in combination with the fishing rod, fishing line from the fishing line reel of the fishing rod is preferably wrapped around the catch device in travel of the fishing line from the fishing line reel to the line guide on the flexible strip.

The wind flap may comprise a plate having a series of slits therein through which the flexible strip passes. In one alternative, the flexible strip and the wind flap may be of a single unitary integral construction.

### BRIEF DESCRIPTION OF THE DRAWINGS

In the accompanying drawings, which illustrate a exemplary embodiments of the present invention:

FIG. 1 is a side elevational view of an ice fishing apparatus according to a first embodiment of the present invention in use on a frozen over body of water with the ice layer cut away for illustration.

FIG. 2 is a side elevational view of an ice fishing apparatus according to a second embodiment of the present invention in use on a frozen over body of water with the ice layer cut away for illustration.

FIG. 3 is an overhead plan view of a strip of flexible material equipped with a wind flap and line clip for use in an ice fishing apparatus of the present invention, but laid out flat for illustration.

FIG. 4 is a side elevational view of a hook of an alternate design to that used in an auto-set mechanism of the ice fishing apparatus of FIG. 2.

FIG. 5A is an overhead plan view of a strip and wind flap combination like that of FIG. 3 next to an integrally formed alternative in which the strip and wind flap are part of a single unitary member.

FIG. 5B is an overhead plan view of a strip and wind flap combination, in which the wind flap is shaped to resemble a fish, next to an integrally formed alternative in which the strip and wind flap are part of a single unitary member.

### DETAILED DESCRIPTION

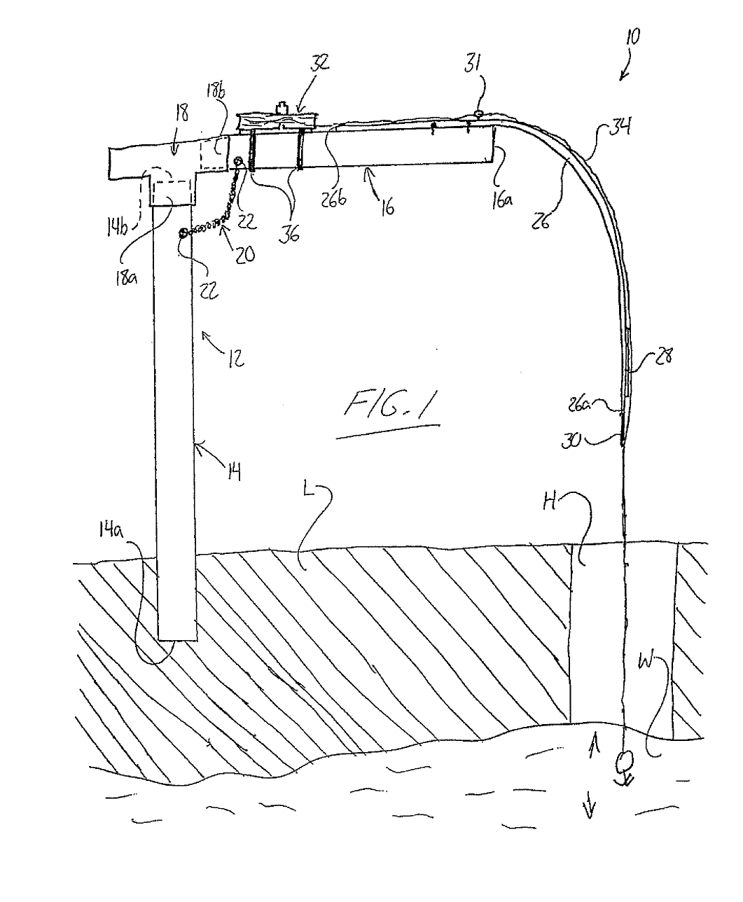

FIG. 1 shows an ice fishing apparatus 10 according to a first embodiment of the present invention. The apparatus 10 features a three piece stand 12 consisting of two pieces of rectangular steel tubing 14, 16 interconnected by a T-fitting tubing connector 18. In use of the apparatus, the first piece of tubing 14 is vertically oriented with its bottom end 14a having been driven into the ice layer L of a frozen body of water to support the stand. The T-fitting 18 is fitted onto the top end 14b of this first tubular element 14 of the stand in order to join the second tubular stand element 16 therewith. Two neighbouring perpendicular branches 18a, 18b of the T-fitting's three hollow branches receive the ends of the tubing pieces 14, 16 therein to support the second tube 16 in a horizontal position projecting perpendicularly away from the first tube 14 adjacent the top end 14b thereof. The resulting stand accordingly has an overall L-shaped structure.

At least one of the two tubular elements 14, 16 of the stand 12 is removable from the respective branch 18a, 18b of the T-fitting 18 so that the stand is collapsible into a more compact storage configuration, for example by laying or leaning the two tubular elements beside one another in parallel or nearly parallel orientations. To prevent loss or misplacement of one of the tubular elements that may occur under complete separation of the two, a flexible chain 20 has its opposite ends bolted or otherwise fixed to opposing ones of the two tubular stand elements 14, 16. The bolts 22 securing the chain 20 to the tubes 14, 16 are situated near the ends of the tubes connected by the T-fitting, but spaced far enough from these ends so as not to interfere with full insertion of the ends of the tubes into the T-fitting sufficiently far to securely connect the tubes in fixed perpendicular positions relative to one another. The chain may be replaced with another flexible element, such as a cable, or the tubes may be pivotally interconnected for movement between a parallel storage configuration and a diverging use configuration.

A flat flexible narrow strip or band of metal 26 has a portion of its length fixed atop the horizontal tubular frame element 16 to extend along the axial direction thereof. The rest of the strip 26 projects outwardly past the distal end 16a of the horizontal tube 16 opposite the vertical tube 14. Near a free end 26a of the strip 26 opposite the strip's connection to the horizontal tube 16, a flat sheet or plate 28 is fixed to the band 26 to form a wind flap. In the illustrated embodiments, this wind flap 28 is rectangular and has a longer of its two dimensions oriented perpendicular to the lengthwise dimension of the strip 26. At a short distance from the wind flap 28 further along the strip 26 toward the free end 26a thereof, a paperclip 30 is fixed to the strip 26 to project outward past a side and/or end edge thereof. At a position near the distal end 16a of the horizontal tube 16, the portion of the strip 26 mounted substantially flush thereatop is equipped with an eyelet 31 forming a fishing line guide, for example as may provided by an eyebolt threadingly fastened to the horizontal tube 16 through the strip 26.

Between the end 26b of the strip disposed atop the horizontal tube 16 and the T-fitting 18, a reel 32 of ice fishing line is secured atop the horizontal tube 16 and rotatable in a conventional manner to wind the ice fishing line 34 thereon and allow deployment of the line therefrom. In the illustrated embodiments, the reel's frame or housing on which the spool is rotatably mounted is fixed to the horizontal tube 16 by zip ties 36 wrapped therearound, but it will be appreciated that other mounting arrangements may be employed. Line 34 from the reel 32 is passed along the axial direction of the horizontal tube 16 beneath it through the eyelet 31 and onward past the distal end 16a of the horizontal tube 16 along the strip 26. At the free end 26a of the strip, the fishing line 34 is engaged by paper clip in its passage therethrough. The remainder of the length of line deployed from the reel 32 hangs downward from this clipped engagement of the line at the free end of the strip to depend downward into the water W below the ice layer L of the frozen lake, river or sea through the hole formed in the ice. In a conventional manner, the fishing line 24 is equipped with a hook and suitable bait at its free end.

With the strip 26 supported only at the portion thereof secured on the horizontal tube 16 of the stand 12, the weight of the rest of the strip 26, the wind flap 28, the mounting of the clip 30 on the strip, and the length of line hanging from the clip with the hook and bait or lure pulls the unsupported free end of the strip downward, giving the strip the illustrated shape curving downwardly toward the ice layer L from the distal end 16a of the stand's horizontal tube 16. Wind moving air across the frozen surface of the body of water will exert pressure against a face of the wind flap 28, causing the strip 26 to deflect out of the position it would normally reside in under the absence of any such external forces. As the wind subsides, the strip will thus tend to move back toward this normal position. Accordingly, as wind velocity changes with shifts in speed and direction, the pressure exerted on the wind flap will change, and these ongoing changes in wind conditions will accordingly cause ongoing back and forth movement of the wind flap. With the wind flap secured on the strip 26 and accordingly having its motion constrained thereby, this back and forth movement has upward and downward components of motion. Therefore, the wind will cause the end portion of the strip on which the wind flap and clip are mounted to move alternately up and down on a repeating basis, which in turn moves the bait and hook on the end of the fishing line up and down within the body of water W below the ice layer L thereatop. The ice fishing apparatus thus has an automatic jigging functionality continuously lifting and lowering the line in the water.

With reference to FIG. 1, the fishing line 34 is strung by a user to pass by the wind flap 28 on the front side thereof facing away from the stand 12. When the apparatus is initially set up by the user to hang the fishing line 34 freely into the water W from the clip 30 at the end of the strip 26, the amount of line 34 deployed from the reel 32 is selected to provide sufficient slack in the line between its winding on the spool of the reel 32 and its connection to the clip 30 at the end of the strip 26 so that tension in the line does not affect the hanging position of the strip's free end 26a or interfere with the up and down movement thereof provided by the wind. When a fish strikes the bait, biting onto and pulling the hook further into the water, the pull frees the line 34 from the engagement by the paper clip 30 and pulls the slack out of the line. The introduction of tension to the line by this pulling will tend to straighten the line from the eyelet 31 to where the line passes in front of the wind flap, this section of line thus deviating from over the strip at the eyelet 31 to beside the strip as it extends toward the wind flap, and this tightening of the line in front of the wind flap 28 will tend to increase the strip's curve to point more directly downward toward the hole H in the ice from the distal end 16a of the stand 12, or at least reduce the range of movement of the wind flap and strip under the effect of the wind. Accordingly, the strip provides a visual indicator of a fish strike on the line by its change in curvature or position of its free end and/or a reduction of its bouncing or jigging motion. Furthermore, where a dark coloured fishing line is used to contrast with the ice and snow, the removal of the initial slack from the line to take on a more straight or direct path of travel from the eyelet 31 to the hole H in the ice can also be used as a visual indicator of a strike.

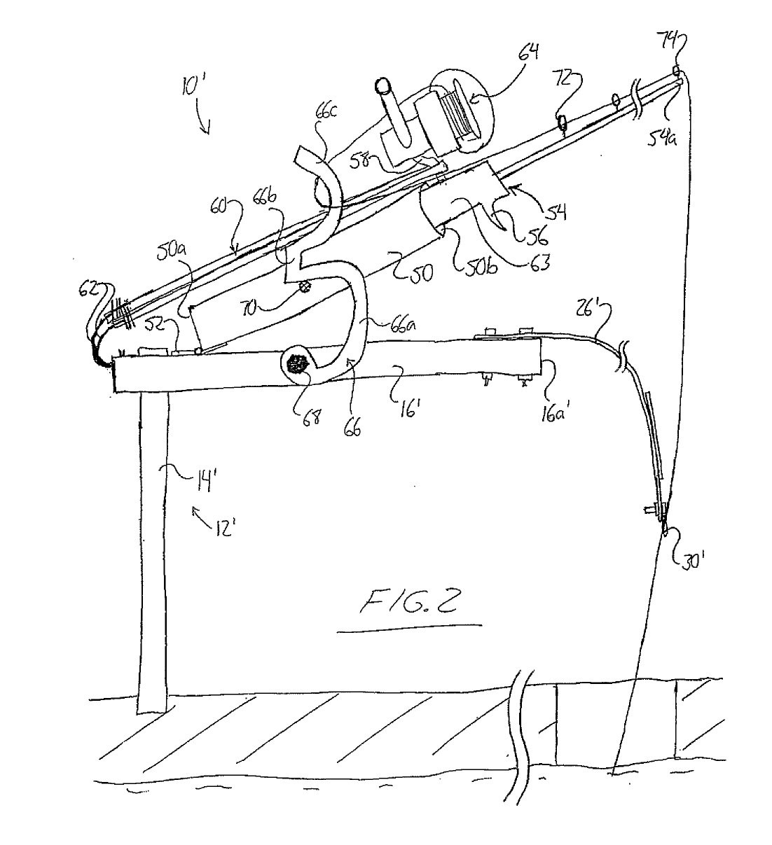

FIG. 2 shows a second embodiment ice fishing apparatus 10′ having a similar arrangement of an L-shaped stand 12′ equipped with a flexible strip 26′ projecting from the distal end 16a′ of the stand's horizontal member 16′. The second embodiment differs primarily in that instead of an ice fishing reel fixed to the horizontal tube of the stand, the apparatus features a fishing rod holder adapted to support a conventional fishing rod and configured to provide an auto-set function that will automatically set the hook in the fish's mouth upon striking the bait. FIG. 2 shows other minor differences from the illustrated embodiment of FIG. 1, particularly showing that the upright and horizontal stand members may be permanently fixed together and need not necessarily be interconnected by a T-fitting and illustrating that the connections between the strip and the horizontal tube and the strip and the line clip may be provided by bolting. These are of course only examples, and it will be appreciated that any of a variety of known means for interconnecting components of an assembly may be applied.

The rod holder 50 of the second embodiment apparatus 10′ is a hollow cylinder or tube open at one or both ends. A hinge 52 has one leaf thereof fixed to the top of the horizontal tube 16′ at a position therealong adjacent the connection thereof to the vertical tube 14′. The second leaf of the hinge 52 is fixed to the bottom of the rod holder 50 adjacent one end 50a thereof. The knuckle and pin assembly of the hinge is oriented horizontally in a direction perpendicularly transverse to the axial direction of the horizontal tube 16′. The rod holder 50 has its axis lying in the same vertical plane as the axis of the horizontal tube 16′ and is pivotal about the hinge axis from a position lying parallel to the horizontal tube 16′ on top thereof back toward the end of the stand opposite that from which the strip projects. The end 50b of the rod holder 50 opposite the hinge 52 is left open to receive the handle of a fishing rod 54. The hinged end of the rod holder may be closed so that the end of the fishing rod handle abuts against this closed end to define the fully inserted position of the fishing rod, or the projecting features of the fishing rod such as a finger grip 56 or reel support 58 may alternatively define this position of the rod by abutting against the end face of the rod holder at the open end 50b if such abutment places the handle end of the rod inside the rod holder, and not projecting out the hinge-end thereof.

The fishing rod 54 projects from the open end 50b of the rod holder 50 and situates the rod's distal end 54a opposite the handle past the distal end 16a′ of the stand 12′. A bungee cord 60 equipped with hooks 62 at its two ends has these ends hooked to the horizontal tube 16′ at an end thereof situated just past the vertical tube 14′ on the side thereof opposite the horizontal tube's distal end 16a′ where the strip 26 is mounted. The hooks 62 curve through the open end of the horizontal tube 16 and then upward through a common hole or two separate holes in the top wall of the tube 16 to secure the elastic bungee cord 60 to the horizontal tube. It will be appreciated that if the rod-holding embodiment used the T-fitting junction of the first embodiment, the hooks could similarly be employed at the open end of the third branch of the T-fitting shown unused in FIG. 1. Either way, the end result is securing of the bungee cord ends to the effective end of the horizontally projecting top portion of the support stand. With its two ends secured to the stand at a common point along the horizontally projecting part thereof, the bungee cord 60 wraps around the reel support 58 projecting outward from the rod handle 63 to support the reel 64 in a conventional manner outside the rod holder 50. The elastic nature of the bungee cord pulls the reel support 58 toward the proximal end of the horizontal tube 16′ engaged by the hook-equipped ends of the cord 60, tending to rotate the rod-carrying holder 50 about the hinge axis toward the horizontal tube's proximal end into a substantially vertical orientation positioning the fishing rod upright.

Still referring to FIG. 2, a catch member 66 is connected to a side of the horizontal tube 16′ by a pivot pin 68 in order to pivot about a horizontal axis parallel to the hinge axis. Viewed from a side of the stand in a plane normal to the hinge and pivot pin axes, the catch member 66 features a generally C-shaped first section 66a having the pivot pin 68 pass through it near one of its ends. A second linear section 66b projects from the other end of the C-shaped first section along a radial path from the pivot pin axis. A C-shaped third section 66c of the catch member opens in the same direction as the C-shaped first section 66a so that the open sides of the C-shapes are situated at the pivot axis' radial plane in which the linear section 66b lies. A catch pin 70 projects horizontally from the rod holder 50 to the same side thereof on which the catch member 66 is disposed by a distance sufficient to slightly pass the vertical plane in which the catch member is pivotal. The elastic bungee cord forms a biasing device to connect to the rod holder through the fishing rod and bias the rod holder and the rod supported therein into a more raised upright position that the natural horizontal position in which the rod holder and rod would lie atop the horizontal tube 16′ under the effect of their weight about the hinge axis, and the catch member 66 forms a device employable into the position of FIG. 2 to engage the catch pin on the rod holder and thereby retain the rod holder and rod cord in a lowered position more parallel to the horizontal tube 16′ than in the raised position.

The catch member 66 further cooperates with the fishing line 34′ of the fishing reel 64 to also form part of a trigger mechanism that will automatically release the catch member 66 from the catch pin 70 when a fish strikes the bait and pulls on the line, causing the rod holder 50 and the rod 54 carried therein to pivot upward and rearward to the raised position under the bias of the bungee cord 60 (front/forward and rear/rearward being used herein to refer to the strip-equipped end and the end opposite the flexible strip, respectively). This action raises the distal end 54a of the fishing rod 54 from which the line extends downward toward the hole H in the ice, and with the line 34′ having been freed from the clip 30′ at the end of the flexible strip 26′ by the bite and pull of the fish, the sudden upward jerking of the rod by the biasing action of the bungee cord tugs on the line and causes the hook to be set in the fish's mouth.

To accomplish this auto-set action, the fisherman installs his fishing rod 54 in the rod holder 50 by placing the handle end of the rod therein, wraps the bungee cord around the front of the reel support 58 or the finger grip 56 of the rod 54 and engages the hooked ends 62 of the bungee cord to the stand at the effective end of the horizontal portion 16′ thereof. As shown in FIG. 2, with the catch member 66 projecting upward from the horizontal tube 16′ when the bungee cord is set in this manner, or if the fisherman instead moves the catch member 66 into an upright position only after having installed the bungee cord and forced the rod holder and rod downward toward the horizontal tube 16′ against the elastic action of the bungee cord, the C-shaped first section 66a of the catch member curves upwardly and forwardly from the pivot pin 68 and then rearwardly over the catch pin 70 so that contact of the catch pin 70 against the C-shaped first section 66a proximate the end thereof opposite the pivot pin 68 blocks pivoting of the rod holder 50 further toward the more upright raised position toward which it is biased by the bungee cord 60. Between the spool of the reel 64 and a first eyelet or line guide 72 on the rod 54 nearest the handle 63 thereof, the line 34′ is wrapped about the C-shaped third portion 66c of the catch member so that the line 34′ extends rearward from the spool, then around the catch member's third portion 66c and finally forward therefrom to pass through the fishing rod eyelets to the distal end thereof, where the line 34′ then depends downward toward the free end of the flexible strip 26′ where it is clipped in place by clip 30′ mounted thereon before continuing further downward into the water W through the hole H in the ice layer L. With the line 34′ wrapped around the third section 66c of the catch member 66, when a fish takes the bait and pulls the line, not only does this release the line from the clip 30′ and take slack out of the line between the fishing rod eyelet 74 nearest the distal end 54a of the rod (in similar action to the first embodiment, but it further pulls the third section 66c of the catch member 66 forward, pivoting the catch member forward and downward about the pivot pin 68 and thus releasing the catch pin 70 from inside the C-shaped first section 66a of the catch member and allowing the rod holder 50 and fishing rod 54 to pivot upwardly rearward about the axis of the hinge 52 to set the hook.

Prior to a strike, the fishing apparatus cooperates with the rod 54 to operate in the same manner as the first embodiment, with wind fluctuations driving an up and down jigging motion of the baited end of the line in the water by way of the wind flap on the flexible strip. When a fish strikes, not only does a change in the curvature of the strip or reduction or elimination of the wind-actuated up and down motion of the end thereof provide a visual signal indicative of the catch, but the sudden pivot of the fishing rod 54 and holder 50 to provide the automatic setting of the hook and the resulting new raised positions of the rod and holder provide a further visual indicator of the strike.

FIGS. 1 and 2 lack detail on how the wind flap 28 is secured on the flexible strip 26, but FIG. 3 shows one example of how this assembly may be achieved. Here, the rectangular flap 28′ is provided with two slits or narrow slots 28a, 28b positioned centrally along the lengthwise dimension of the flap and each extending only a partial portion of this dimension slightly exceeding the width of the strip 26. The two slits are parallel and spaced apart along the shorter width dimension of the flap so that the flexible strip 26 can simply be passed through the slits so as to alter from one side of the flap to the other at the passage through each slit. Of course this is only one example of how the flap can be secured in place, and other alternatives include fixing the flap to the strip using adhesive, screws or other fasteners.

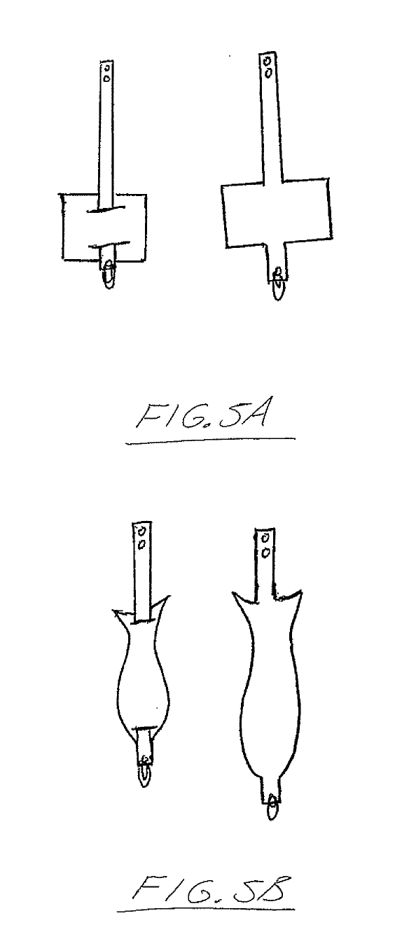

Another alternative would be to form the flap integrally with the flexible strip as a one-piece single unitary integral member of metal or plastic. However, the attachment of the flap to a separate strip using a slot, or preferably more than one slot, has the advantage of allowing adjustment of the position of the flap along the strip, for example to suit different wind conditions. In high wind conditions, the flap can be moved further up the strip to take on a less-vertical orientation catching less wind, to give the strip a more controlled limited range of movement than would otherwise be experienced during gusting or high-velocity wind conditions. In low wind conditions, the flap is moved closer to the free end of the strip pointing downward toward the hole in the ice, giving the flap a more vertical position for greater action of the wind against it. FIGS. 5A and 5B illustrate slotted wind flaps slid onto flexible strips and corresponding integrally formed strip/flap combinations having a similar resulting structure. FIG. 5B illustrates how the wind flap is not limited to a rectangular shape and may be given a shape resembling a fish, something else reflective of the fishing context in which the invention is used, or other things including other animals or objects.

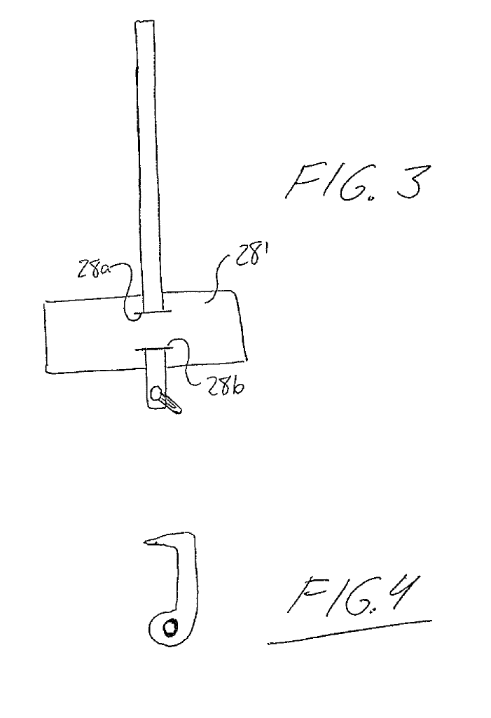

Although the catch member of the FIG. 2 embodiment is described above in terms of a relatively specific shape, it will be appreciated that other bent, curved or hook-like members may similarly be used. For example, it is speculated that a conventionally shaped hook shown in FIG. 4 simply having an eyelet at one end of a generally linear leg and a single-bend or single-curve hook end at the other could be used, the hook end passing over the catch pin when positioned to retain the rod holder in the lowered position and the fishing line wrapping around the hook below the hook end to pull it forwardly off the catch pin under tugging of the line.

It will be appreciated that materials, shapes and structures may be altered from those explicitly detailed herein above without departing from the scope of the present invention. For example, the upright and laterally projecting parts of the support stand need not necessarily be tubular, linearly extending or rectangular or square in cross-section. However, hollow tubes minimize weight, flat sided cross-sections provide suitable mounting surfaces for components atop the laterally projecting and rectangular tubing is a readily available material requiring no specialized manufacturing. The laterally projecting portion of the stand extending from the upright portion engaged in the ice need not necessarily be disposed at the very top end of the upright portion. Alternative releasable clipping arrangements suitable for gripping for the fishing line with sufficient strength to move with the wind-driven movement of the band yet releasable by the pulling of a hooked fish may be employed in place of a paperclip near the end of the flexible strip. One example construction employs ½-inch square tubing 10-inches long for the horizontal member and 30-inches long for the vertical member, a ¾-inch T-fitting with branches of circular cross-section and a 1-inch wide by 20-inch long strip or band.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An ice fishing apparatus comprising:
a support stand comprising:
a first stand element having a first end thereof arranged to engage a frozen surface of a body of water with the first stand element projecting upward therefrom; and
a second first stand element coupled to the first stand element at a connection point spaced from the first end thereof in a position projecting laterally therefrom at a distance above the frozen surface;
a flexible strip having a fixed end coupled to the second stand element and extending past a distal end of the second stand element opposite the first stand element;
a wind flap coupled to the flexible strip at a position therealong between the distal end of the second stand element and a free end of the flexible strip opposite the fixed end thereof;
a reel support arrangement coupled to the support stand to support a reel of fishing line thereon; and
a clip coupled to the flexible strip at a position therealong between the wind flap and the free end thereof for gripping the fishing line between a hook-carrying end thereof and the reel to move the hook-carrying end of the fishing line with the flexible strip under action of moving air on the wind flap.

2. The ice fishing apparatus of claim 1 wherein the second stand element is releasable from the position projecting laterally from the first stand element.

3. The ice fishing apparatus of claim 1 wherein the second stand element is selectively detachable from the first stand element at the connection point;

4. The ice fishing apparatus of claim 3 wherein a flexible link connects the first and second stand elements to prevent complete separation thereof when the second stand elements are detached at the connection point.

5. The ice fishing apparatus of claim 1 wherein the second stand element is movable into a position extending along the first stand element for storage.

6. The ice fishing apparatus of claim 1 wherein the connection point is defined by a branched connector receiving ends of the first and second stand elements in hollow branches of the connector disposed at rights angles to one another.

7. The ice fishing apparatus of claim 1 wherein at least one of the stand elements comprises a respective length of tubing.

8. The ice fishing apparatus of claim 7 wherein each length of tubing is rectangular in cross-section.

9. The ice fishing apparatus of claim 1 wherein the reel support arrangement comprises a rod holder coupled to the stand proximate the second stand element and arranged to receive a handle end of a fishing rod in order to support the fishing rod and a fishing line reel installed thereon on the stand element so that the fishing rod extends from the rod holder along an axis thereof toward the distal end of the second stand element.

10. The ice fishing apparatus of claim 9 wherein a pivotal connection supports the rod holder on the stand to pivot about a horizontal axis transverse to the second stand element between a lowered rod position and a raised rod position in which the axis of the rod holder angles upwardly moving along the axis toward the distal end of the second stand element more than in the lowered rod position, and the ice fishing apparatus further comprises a biasing device on the stand arranged to bias the rod holder into the raised rod position relative to the stand and a catch device movable between an engaged position retaining the rod holder in the lowered rod position against the bias of the biasing device and a disengaged position releasing the rod holder to trigger movement thereof the rod holder into the raised rod position under the bias of the biasing device.

11. The ice fishing apparatus of claim 10 wherein the biasing device comprises an elastic member to connect to the stand at a position on one side of the pivotal connection opposite the distal end of the second stand element and connect to the rod holder on an opposite side of the pivotal connection to pull a rod-receiving end of the rod holder upwardly about the horizontal axis.

12. The ice fishing apparatus of claim 11 wherein the elastic member comprises a bungee cord.

13. The ice fishing apparatus of claim 11 in combination with the fishing rod, the elastic member extending about a feature of the fishing rod at a portion thereof projecting from the rod receiving end of the rod holder to pull the rod receiving end of the rod holder upwardly about the horizontal axis toward where the two ends of the elastic member connect to the second stand element.

14. The ice fishing apparatus of claim 13 wherein the elastic member extends about a finger grip of the fishing rod.

15. The ice fishing apparatus of claim 11 wherein the first and second stand elements are connected by a T-junction and the elastic member has two ends secured to the stand on the one side of the pivotal connection by hooking into an open end of a branch of the T-junction opposite another branch thereof supporting the second stand element.

16. The ice fishing apparatus of claim 10 wherein the catch device is movably supported on one of the support stand and the rod holder and movable relative thereto, the catch device engaging a catch element on an opposite one of the support stand and the rod holder in the engaged position to retain the rod holder in the lowered rod position.

17. The ice fishing apparatus of claim 16 wherein the catch element comprises a lateral projection on the opposite one of the stand and the rod holder and the catch device on the one of the stand and the rod holder bends over or under the lateral projection respectively in the engaged position.

18. The ice fishing apparatus of claim 17 in combination with the fishing rod, fishing line from the fishing line reel of the fishing rod being wrapped around the catch device in travel of the fishing line from the fishing line reel to the clip on the flexible strip.

19. The ice fishing apparatus of claim 1 wherein the wind flap comprises a plate having a series of slits therein through which the flexible strip passes.

20. The fishing apparatus of claim 1 wherein the flexible strip and the wind flap are of a single unitary integral construction.
